(19) United States
(12) Patent Application Publication
(10) Pub. No.: US 2026/0117028 A1
(43) Pub. Date: Apr. 30, 2026

(54) CURABLE SILICONE COMPOSITION AND CURED PRODUCT THEREOF

(71) Applicant: DOW SILICONES CORPORATION, Midland, MI (US)

(72) Inventor: Juyoung YOOK, Chungcheongbuk-Do (KR)

(21) Appl. No.: 18/840,623

(22) PCT Filed: Feb. 23, 2023
(86) PCT No.: PCT/US2023/013659

§ 371 Date: Aug. 22, 2024

Related U.S. Application Data
(60) Provisional application No. 63/313,392, filed on Feb. 24, 2022.

(51) Int. Cl. C08G 77/20; C08G 77/12

(52) U.S. Cl. CPC C08G 77/20; C08G 77/12

(57) ABSTRACT

This disclosure relates to a curable silicone composition comprising: (A) an organopolysiloxane resin having an alkenyl group in a molecule; (B) an organosiloxane oligomer having a viscosity at 25° C. of not more than 1,000 mPa·s, having at least one silicon atom-bonded alkenyl group or silicon atom-bonded hydrogen atom, and having at least one silicon atom-bonded aryl group in a molecule; (C) an organosilicon compound selected from (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, (C₃) a disilylbenzene, and a mixture thereof; and (D) a hydrosilylation reaction catalyst. The composition has an excellent handleability at a room temperature without using a solvent, and cures to form a non-sticky cured product at a room temperature with an excellent melt viscosity by heating.

### CROSS-REFERENCE TO RELATED APPLICATIONS

This application claims priority to and all advantages of U.S. Provisional Patent Application No. 63/313,392 filed on 24 Feb. 2022, the content of which is herein incorporated by reference.

### TECHNICAL FIELD

The present invention relates to a curable silicone composition and a cured product thereof.

### BACKGROUND ART

Curable silicone compositions cure to form cured products having excellent heat resistance, electrical insulating properties and weatherability, so that they are widely used as protective coating agents, encapsulants or sealants of electric/electronic equipment.

For example, Patent Document 1 discloses a curable silicone compositions comprising: an organopolysiloxane resin consisting of CH₂═CH(CH₃)₂SiO_{1/2} units, (CH₃)₃SiO_{1/2} units and SiO_{4/2} units, an organopolysiloxane having at least two alkenyl groups in a molecule, an organopolysiloxane having at least two alkenyl groups in a molecule, an organopolysiloxane having at least two silicon atom-bonded hydrogen atoms in a molecule, and a hydrosilylation reaction catalyst, cure cured products with a hot-melt property.

However, such the curable silicone composition is typically solvent-based composition. Solvents are employed primarily to reduce viscosities of the curable silicone compositions and removed after application of the compositions. As with any solvent-based curable silicone compositions, special precautions must be taken to contain and avoid environmental exposure of the solvents and avoid flammable and explosive conditions as many of the solvents are flammable.

### PRIOR ART DOCUMENTS

### Patent Documents

Patent Document 1: Korean Patent Application Publication No. KR 10-2021-0084572 A

### SUMMARY OF INVENTION

### Technical Problem

An object of the present invention is to provide a curable silicone composition which has an excellent handleability at a room temperature without using a solvent, and cures to form a non-sticky cured product at a room temperature with an excellent melt viscosity by heating.

### Solution to Problem

The curable silicone composition of the present invention comprises:

(A) an organopolysiloxane resin represented by the following average unit formula:

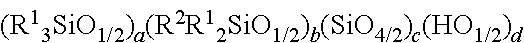

wherein each R¹ is independently an alkyl group; R² is an alkenyl group; and “a”, “b”, “c” and “d” are numbers satisfying the following conditions: a≥0, b>0, 0.3≤c≤0.7, 0≤d≤0.05, and a+b+c=1;

(B) an organosiloxane oligomer having a viscosity at 25° C. of not more than 1,000 mPa·s, and selected from (B₁) an organosiloxane oligomer having at least one silicon atom-bonded alkenyl group and at least one silicon atom-bonded aryl group in a molecule, (B₂) an organosiloxane oligomer having at least one silicon atom-bonded hydrogen atom and at least one silicon atom-bonded aryl group in a molecule, and a mixture of components (B₁) and (B₂);

(C) an organosilicon compound selected from (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, (C₃) a disilylbenzene represented by the following general formula:

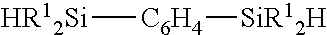

wherein each R is as described above,
   and a mixture thereof; and

(D) a catalytic amount of a hydrosilylation reaction catalyst,
wherein an amount of component (A) is in a range of from 60 to 75 mass %, an amount of component (B) is in a range of from 5 to 35 mass %, and an amount of component (C) is in a range of from 0 to 30 mass %, each based on a total mass of components (A) to (C), with the proviso that a molar ratio of all silicon atom-bonded hydrogen atoms relative to all silicon atom-bonded alkenyl groups in components (A) to (C) is more than 0.30 and not more than 0.90.

In various embodiments, component (B₁₁) is at least one selected from (B₁₁) an organosiloxane oligomer represented by the following general formula:

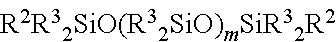

wherein each R is independently an alkenyl group; each R³ is independently an alkyl group or an aryl group, with the proviso that at least one R³ is an aryl group; and “m” is an integer of 0 to 10.

In various embodiments, component (B₁₁) is at least one selected from organosiloxane oligomers represented by the following formulae:

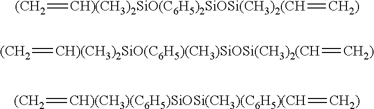

In various embodiments, component (B₂) is at least one selected from (B₂₁) an organosiloxane oligomer represented by the following general formula:

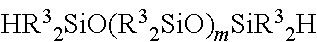

wherein each R³ is independently an alkyl group or an aryl group, with the proviso that at least one R³ is an aryl group; and “m” is an integer of 0 to 10.

In various embodiment, component (B₂₁) is at least one selected from organosiloxane oligomers represented by the following formulae:

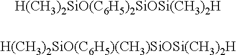

In various embodiments, the curable silicone composition further comprises: (E) a hydrosilylation reaction inhibitor, in an amount of 0.1 to 10,000 ppm in this component in terms of mass units with respect to the composition.

In various embodiments, the curable silicone composition further comprises: (F) an adhesion promotor, in an amount of at most 10 parts by mass relative to 100 parts by mass of a total mass of components (A) to (C).

The cured product of the present invention is obtained by curing the above-mentioned curable silicone composition.

### Effects of Invention

The curable silicone composition of the present invention has an excellent handleability at a room temperature without using a solvent, and cures to form a non-sticky cured product at a room temperature with an excellent melt viscosity by heating.

### Definitions

The terms “comprising” or “comprise” are used herein in their broadest sense to mean and encompass the notions of “including,” “include,” “consist(ing) essentially of,” and “consist(ing) of”. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, the term “about” applies to both numerical values when associated with a range of values. Moreover, the term “about” may apply to numerical values even when not explicitly stated.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

### DETAILED DESCRIPTION OF THE INVENTION

The curable silicone composition of the present invention will be explained in detail.

Component (A) is an organopolysiloxane resin represented by the following average unit formula:

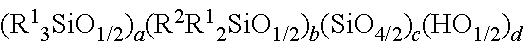

In the formula, each R¹ is independently an alkyl group. The alkyl groups are exemplified by alkyl groups with 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups and dodecyl groups. Among these, methyl groups are preferable.

In the formula, R² is an alkenyl group. The alkenyl groups are exemplified by alkenyl groups with 2 to 12 carbon atoms such as vinyl groups, allyl groups, butenyl groups, pentenyl groups, hexenyl groups, heptenyl groups, octenyl groups, nonenyl groups, decenyl groups, undecenyl groups, and dodecenyl groups. Among these, vinyl groups are preferable.

In the formula, “a”, “b”, “c” and “d” are numbers satisfying the following conditions: a≥0, b>0, 0.3≤c≤0.7, 0≤d≤0.05, and a+b+c=1, optionally 0.1≤a≤0.5, 0.01≤b≤0.2, 0.4≤c≤0.7, 0≤d≤0.05, and a+b+c=1, or optionally 0.2≤a≤0.5, 0.01≤b≤0.2, 0.4≤c≤0.7, 0≤d≤0.05, and a+b+c=1. This is because, if “a”, “b”, “c” and “d” are numbers within the ranges mentioned above, a cured product obtained by curing the present composition will have appropriate hardness and mechanical strength.

A molecular weight of the organopolysiloxane resin for component (A) is not limited, however, its number average molecular weight (Mn) measured in terms of standard polystyrene by gel permeation chromatography (GPC) is preferably at least 1,500 g/mol, alternatively at least 2,000 g/mol, or alternatively at least 3,000 g/mol; while at the same time the Mn is preferably not more than 6,000 g/mol; alternatively not more than 5,500 g/mol. The Mn of component (A) can be an arbitrary range that combines the upper and lower limits described above. Note that if component (A) is in a solid state at 25° C. and it is difficult to uniformly mix other components in the present composition, such can be resolved by preparing an organic solution of component (A) in advance, and mixing with a portion or all of components (B) and (C), after which the used organic solvent can be removed from this mixture. Note that the organic solvent which can be used to prepare the organic solution of component (A) can be used as long as it can dissolve component (A) and be easily removed. While not limited thereto, specific examples thereof include: aromatic hydrocarbons such as toluene and xylene; and aliphatic hydrocarbons such as hexane and heptane.

Component (A) is used in an amount of from 60 to 75 mass % based on a total mass of components (A) to (C). This is because, if the amount is equal to or above the lower limit of the ranges described above, a cured product obtained by curing the present composition will have appropriate hardness and mechanical strength, whereas the amount is equal to or below the upper limit of the ranges described above, the composition has suitable viscosity at 25° C.

Component (B) is an organosiloxane oligomer to impart the curable silicone composition with a flowable property, and to impart a cured product obtained by curing the composition with hotmelt property. A molecular structure of the organosiloxane oligomer for component (B) is not limited, however, are exemplified by straight chain, partially branched straight chain. A molecular weight of the organosiloxane oligomer for component (B) is not limited, however, it is preferably not more than 2,000 g/mol, alternatively not more than 1,500 g/mol. Such the organosiloxane oligomer typically has a viscosity at 25° C. of not more than 1,000 mPa·s, alternatively not more than 500 mPa·s, or alternatively not more than 100 mPa·s. Note that in the present specification, viscosity is the value measured using a type B viscometer according to ASTM D 1084 at 23±2° C.

The organosiloxane oligomer for component (B) also act as a chain extending agent or a crosslinking agent for the composition, and is selected from (B₁) an organosiloxane oligomer having at least one silicon atom-bonded alkenyl group and at least one silicon atom-bonded aryl group in a molecule, (B₂) an organosiloxane oligomer having at least one silicon atom-bonded hydrogen atom and at least one silicon atom-bonded aryl group in a molecule, and a mixture of components (B₁) and (B₂).

The organosiloxane oligomer for component (B₁) is typically an organosiloxane oligomer represented by the following general formula:

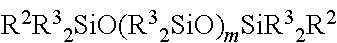

In the formula, each R² is independently an alkenyl group, and examples thereof include the same groups as those described above. Among these, vinyl groups are preferable.

In the formula, each R³ is independently an alkyl group or an aryl group. Examples of alkyl groups for R³ include the same alkyl groups as R¹ described above. Examples of aryl groups for R³ include aryl groups with 6 to 12 carbon atoms such as phenyl groups, tolyl groups, xylyl groups and naphthyl groups. However, at least one R³ is an aryl group, typically a phenyl group.

In the formula, “m” is an integer of 0 to 10, alternatively an integer of 0 to 5, alternatively an integer of 0 to 3, or alternatively an integer of 0 or 1.

Component (B₁) is typically at least one selected from organosiloxane oligomers represented by the following formulae:

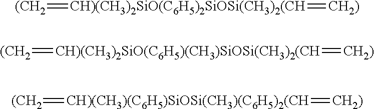

The organosiloxane oligomer for component (B₂) is typically an organosiloxane oligomer represented by the following general formula:

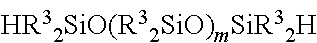

In the formula, each R³ is an alkyl group or an aryl group, and examples thereof include the same groups as those described above. However, at least one R³ is an aryl group, typically a phenyl group.

In the formula, “m” is an integer of 0 to 10, alternatively an integer of 0 to 5, alternatively an integer of 0 to 3, or alternatively an integer of 0 or 1.

Component (B₂) is typically at least one selected from organosiloxane oligomers represented by the following formulae:

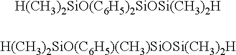

Component (B) is used in an amount of from 5 to 35 mass %, alternatively in an amount of from 5 to 30 mass %, each based on a total mass of components (A) to (C). This is because, if the amount is equal to or above the lower limit of the ranges described above, the composition has good handleability, whereas the amount is equal to or below the upper limit of the ranges described above, the obtained cured product has good transparency. The organosiloxane oligomer for component (B) may be a mixture of components (B₁) and (B₂). However, the amounts of components (B₁) and (B₂) are not limited, but the amount of component (B) should be an amount that a molar ratio of all silicon atom-bonded hydrogen atoms relative to all silicon atom-bonded alkenyl groups in components (A) to (C) is in a range of from 0.3 to 0.9.

Component (C) is an arbitrary component and an organosilicon compound selected from (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, (C₃) a disilylbenzene represented by the following general formula:

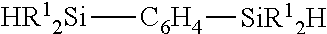

and a mixture thereof.

If a mixture of components (A) and (B) can be cured fully, an addition of component (C) is optional. However, if the mixture cannot be cured for lack of silicon atom-bonded alkenyl groups, component (C₁) should be added, whereas, if the mixture cannot be cured for lack of silicon atom-bonded hydrogen atoms, component (C₂) and/or (C₃) should be added. Furthermore, if the cured product obtained by curing the present composition is hard, component (C) as a chain extending agent should be added, whereas, if the cured product obtained by curing the present composition is soft, component (C) as a crosslinking agent should be added.

Component (C₁) is an organopolysiloxane having at least one alkenyl group and not having a silicon atom-bonded aryl group and SiO_{4/2} unit in a molecule. Examples of the alkenyl groups include alkenyl groups with 2 to 12 carbon atoms such as vinyl groups, allyl groups, butenyl groups, pentenyl groups, hexenyl groups, heptenyl groups, octenyl groups, nonenyl groups, decenyl groups, undecenyl groups and dodecenyl groups. Among these, vinyl groups are preferable. In addition, examples of groups bonding to silicon atoms other than alkenyl groups in component (C₁) include alkyl groups with 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups and dodecyl groups.

A molecular structure of component (C₁) is not limited, but is typically a straight-chain structure, a partially branched straight-chain structure, a branched-chain structure, or a cyclic structure. Component (C₁) may be one type of organopolysiloxane having these molecular structures or may be a mixture of two or more types of organopolysiloxanes having these molecular structures.

Examples of such component (C₁) include dimethylpolysiloxanes capped at both molecular chain terminals with dimethylvinylsiloxy groups, copolymers of dimethylsiloxane and methylvinylsiloxane capped at both molecular chain terminals with dimethylvinylsiloxy groups, copolymers of dimethylsiloxane and methylvinylsiloxane capped at both molecular chain terminals with trimethylsiloxy groups, and mixtures of two or more types thereof.

Component (C₂) is an organopolysiloxane having at least one silicon atom-bonded hydrogen atom and not having a silicon atom-bonded aryl group in a molecule. Examples of groups bonding to silicon atoms in component (C₂) include alkyl groups having from 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups and dodecyl groups.

A molecular structure of component (C₂) is not limited, but is typically a straight-chain structure, a partially branched straight-chain structure, a branched-chain structure, a cyclic structure, or a three-dimensional reticular structure. Component (C₂) may be one type of organopolysiloxane having these molecular structures or may be a mixture of two or more types of organopolysiloxanes having these molecular structures.

Examples of such component (C₂) include methylhydrogenpolysiloxanes capped at both molecular chain terminals with trimethylsiloxy groups, copolymers of dimethylsiloxane and methylhydrogensiloxane capped at both molecular chain terminals with trimethylsiloxy groups, dimethylpolysiloxanes capped at both molecular chain terminals with dimethylhydrogensiloxy groups, copolymers of dimethylsiloxane and methylhydrogensiloxane capped at both molecular chain terminals with dimethylhydrogensiloxy groups, copolymers consisting of (CH₃)₂HSiO_{1/2} units and SiO_{4/2} units, copolymers consisting of (CH₃)₂HSiO_{1/2} units, (CH₃)₃HSiO_{1/2} units, and SiO_{4/2} units, and mixtures of two or more types thereof.

Component (C₃) is a disilylbenzene represented by the following general formula:

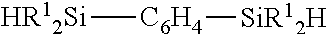

wherein each R¹ is as described above.

Examples of such component (C₃) include the following disilylbenzenes.

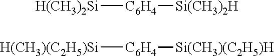

The organosilicon compound for component (C) may be a mixture of components (C₁) and (C₂). However, component (C) typically has a viscosity at 25° C. of not more than 1,000 mPa·s, alternatively not more than 500 mPa·s, or alternatively not more than 100 mPa·s. Note that in the present specification, viscosity is the value measured using a type B viscometer according to ASTM D 1084 at 23±2° C.

Component (C) is used in an amount of from 0 to 30 mass %, alternatively in an amount of from 2 to 30 mass %, each based on a total mass of components (A) to (C). This is because, if the amount is equal to or above the lower limit of the ranges described above, the composition has good handleability, whereas the amount is equal to or below the upper limit of the ranges described above, the composition has good transparency. The organosilicon compound for component (C) may be a mixture of components (C₁) to (C₃).

However, the amounts of components (C₁) to (C₃) are not limited, but the amount of component (C) should be an amount that a molar ratio of all silicon atom-bonded hydrogen atoms relative to all silicon atom-bonded alkenyl groups in components (A) to (C) is in a range of from 0.3 to 0.9.

A molar ratio (“SiH/Vi ratio”) of all silicon atom-bonded hydrogen atoms relative to all silicon atom-bonded alkenyl groups in components (A) to (C) is more than 0.30 and not more than 0.90, alternatively in a range of from 0.31 to 0.80, or alternatively in a range of from 0.34 to 0.70. This is because, if the molar ration is equal to or above the lower limit of the ranges described above, the composition can be fully cured, and a cured product obtained by curing the present composition will have appropriate hardness and non-sticky surface, whereas the molar ratio is equal to or below the upper limit of the ranges described above, the cured product has good hotmelt property.

Component (D) is a hydrosilylation reaction catalyst used to facilitate curing of the present composition. Hydrosilylation reaction catalyst for component (D) is well known in the art and commercially available. Suitable hydrosilylation catalysts include, without limitation, a platinum group metal which includes platinum, rhodium, ruthenium, palladium, osmium, or iridium metal or an organometallic compound thereof and a combination of any two or more thereof. Component (D) is typically a platinum-based catalyst so that the curing of the present composition can be dramatically accelerated. Examples of the platinum-based catalyst include a platinum fine powder, chloroplatinic acid, an alcohol solution of chloroplatinic acid, a platinum-alkenylsiloxane complex, a platinum-olefin complex and a platinum-carbonyl complex, with a platinum-alkenylsiloxane complex being most typical.

In various embodiments, component (D) is a hydrosilylation reaction catalyst that includes complexes of platinum with low molecular weight organopolysiloxanes that include 1,3-divinyl-1,1,3,3-tetramethyldisiloxane complexes with platinum. These complexes may be microencapsulated in a resin matrix. In specific embodiments, the catalyst includes 1,3-divinyl-1,1,3,3-tetramethyldisiloxane complex with platinum.

Examples of suitable hydrosilylation reaction catalysts for component (D) are described in, for example, U.S. Pat. Nos. 3,159,601; 3,220,972; 3,296,291; 3,419,593; 3,516,946; 3,814,730; 3,989,668; 4,784,879; 5,036,117; and 5,175,325 and EP 0 347 895 B. Microencapsulated hydrosilylation reaction catalysts and methods of preparing them are exemplified in U.S. Pat. Nos. 4,766,176 and 5,017,654.

An amount of component (D) in the present composition is an effective quantity for facilitating curing of the present composition. Specifically, in order to satisfactorily cure the present composition, the content of component (D) is typically a quantity whereby the content of catalytic metal in component (D) relative to the present composition is from about 0.01 to about 500 ppm, alternatively from about 0.01 to about 100 ppm, alternatively from about 0.01 to about 50 ppm, alternatively from about 0.1 to about 10 ppm, in terms of mass units.

In various embodiments, the curable silicone composition comprises (E) a hydrosilylation reaction inhibitor in order to adjust the cure rate of the curable silicone composition. In certain embodiments, component (E) includes, without limitation, an alkyne alcohol such as 2-methyl-3-butyn-2-ol, 3,5-dimethyl-1-hexyn-3-ol, or 2-phenyl-3-butyn-2-ol, 1-ethynyl-cyclohexan-1-ol; an ene-yne compound such as 3-methyl-3-penten-1-yne or 3,5-dimethyl-3-hexen-1-yne; or 1,3,5,7-tetramethyl-1,3,5,7-tetravinylcyclotetrasiloxane, 1,3,5,7-tetramethyl-1,3,5,7-tetrahexenylcyclotetrasiloxane, tris[(1,1-dimethyl-2-propynyl)oxy]methylsilane, diallyl maleate or a benzotriazole may be incorporated as an optional component in the present composition.

An amount of component (E) in the present composition is not particularly limited, but if included is typically in an amount of from about 1 to about 10,000 ppm, alternatively an amount of from about 10 to about 5,000 ppm in this component in terms of mass units with respect to the present composition. This is because when the amount of component (E) is greater than or equal to the lower limit of the aforementioned range, storage stability of the composition is good, whereas when the amount of component (E) is less than or equal to the upper limit of the aforementioned range, curability of the composition at low temperatures is good.

The curable silicone composition of the present invention may optionally further comprise (F) a non-functional organopolysiloxane resin represented by the following average unit formula:

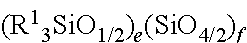

In the formula, each R¹ is independently an alkenyl group, and examples thereof include the same groups as those described above.

In the formula, “e” and “f” are numbers satisfying the following conditions: 0.3≤e≤0.7, 0.3≤f≤0.7, and e+f=1, optionally 0.4≤e≤0.6, 0.4≤f≤0.6, and e+f=1. This is because, if “e” and “f” are numbers within the ranges mentioned above, a cured product obtained by curing the present composition will have appropriate hardness and mechanical strength.

An amount of component (F) in the present composition is not particularly limited, but if included is typically in an amount of from 0 to 30 parts by weight relative to 100 parts by mass of a total of components (A) to (C). This is because when the amount of component (F) is less than or equal to the upper limit of the aforementioned range, handleability of the composition is good.

A viscosity at 25° C. of the present composition is not limited, but it is typically in a range from 100 to 100,000 mPa·s.

Next, the cured product of the present invention will be explained in detail.

The cured product of the present invention is obtained by curing the above-mentioned curable silicone composition. The cured product has non-stick surface. In particular, a storage modulus G′ of the cured product at 20° C. is not limited, but it is typically within a range of 0.05 to 15 MPa, alternatively within a range of 0.07 to 10 MPa, or alternatively within a range of 0.1 to 5 MPa at the condition of frequency=1 Hz, Strain=1%. A melt viscosity at 100° C. of the cured product is not limited, but it is typically in a range from 1 to 5000 Pa·s.

### EXAMPLES

The curable silicone composition and the cured product of the present invention will be described in detail hereinafter using Examples and Comparative Examples. However, the present invention is not limited by the description of the below listed Examples.

### [Gel Permeation Chromatography (GPC)]

GPC data for component (a1) and (a2) was collected using a Waters 2695 Separation Module from Waters Corporation with Waters 2414 Refractive index detector (RID). Three (7.8 by 300 mm) Styragel HR columns (with a molecular weight separation range of 100 to 4,000,000) and a Styragel protection column with toluene (4.6 by 30 mm) are used as the columns. The sample was prepared as a 0.5 mass % solution in toluene and filtered through a 0.45 micron PTFE syringe filter. Using a flow rate of one milliliter per minute, the temperature of the detector and the column are 45° C., the injection volume is 100 microliters, and the running time is 60 minutes. Number average molecular weights (Mn) was calculated relative to linear polystyrene standards covering the molecular weight range of 580 to 2,610,000.

### [Viscosity]

A viscosity at 25° C. of each organosiloxane oligomers, organopolysiloxanes and curable silicone compositions was measured by means of HADV III VISCOMETER (Brookfield) for 1 minutes using the spindle #CP-25. The viscosity was measured for 2 minutes and torque was controlled at the range of 20-80%. The latest data was collected after measurement was completed.

### [Melt Viscosity]

The melting behavior of the resulting silicone hotmelt which obtained by curing the curable silicone composition for 30 minutes at 120° C. could be observed by exposing the solid sample to 100° C. “Melted” means a shape of samples is collapsed and spread out on the substrate. “Not melted” means a shape of sample is maintained. If the sample is not melted at the elevated temperature, melt viscosity could not be measured because it is fully crosslinked. To measure melt viscosity, the hotmelt sample were prepared in the same manner described above, and the sample was mounted onto a parallel-plate geometry (25 mm) of a rheometer (ARES-G2, TA Instruments). Then, the melt viscosity was collected at a fixed shear rate of 1 1/s and a gap of 300 μm at 100° C.

### [Storage Modulus and Loss Modulus]

Samples of the curable silicone compositions were cured and shear modulus of the resulting silicone hotmelt were evaluated as follows: Each sample prepared as described above was poured into a mold (thickness=1 mm) and sandwiched between releasable films. The assembled samples were cured by heating the sample for 30 min at 120° C. After cooled and the releasable film was removed, the sample was mounted onto a parallel-plate geometry (25 mm) of a rheometer (ARES-G2, TA Instruments). Then, the dynamic storage modulus (G′) was collected at a fixed frequency of 1 Hz with a strain of 0.5%, a gap of 300 μm and a normal force of 0 N at 20° C. and 100° C. [Examples 1-8 and Comparative Examples 1-9]

The following components were mixed to uniformity in the quantity proportions shown in Table 1 to produce curable silicone compositions. When component (A) was a solid at 25° C., it was added to other components by using a solvent such as toluene and xylene due to high viscosity. Then, to prepare solventless composition, the solvent was evaporated and replace with other components to facilitate mixing. For example, firstly, component (B) was added to a solution of component (A) dissolved in a solvent. Then, the solvent was removed under reduced pressure by heating with nitrogen bubbling. After cooling to room temperature, component (C) was added. The mixture was mixed at room temperature. Additionally, other components were added to the mixture and mixed at room temperature. The resulting compositions and cured products were evaluated as mentioned above. These results are given in Table 1. The “SiH/Vi ratio” in each of Table 1 indicates a molar ratio of all silicon atom-bonded hydrogen atoms relative to all silicon atom-bonded vinyl groups in components (A) to (C).

The following organopolysiloxane resin was used as component (A).

(a1): an organopolysiloxane resin represented by the following average unit formula:

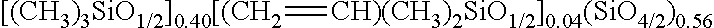

having a vinyl group content of about 1.9 mass % and a number average molecular weight (Mn) of about 5,000, and being a solid at 25° C.

(a2): an organopolysiloxane resin represented by the following average unit formula:

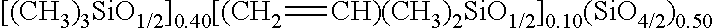

having a vinyl group content of about 3.0 mass % and a number average molecular weight (Mn) of about 3,000, and being a solid at 25° C.

The following organosiloxane oligomers were used as component (B).

(b1): an organosiloxane oligomer represented by the following formula:

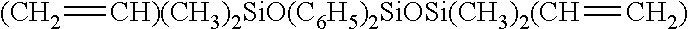

and having a viscosity of 8.7 mPa·s and a vinyl group content of about 14.06 mass %.

(b2): an organosiloxane oligomer represented by the following formula:

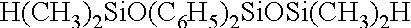

and having a viscosity of 4.4 mPa·s and a silicon atom-bonded hydrogen atom content of about 0.61 mass %

The following organosiloxane oligomers were used as comparison of component (B).

(b3): an organosiloxane oligomer represented by the following formula:

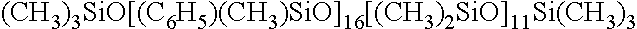

and having a viscosity of 150 mPa·s.

(b4): an organosiloxane oligomer represented by the following formula:

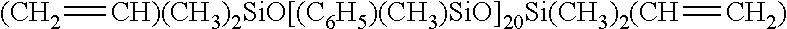

and having a viscosity of 2,300 mPa·s and a vinyl group content of about 1.43 mass %.

The following organopolysiloxanes were used as component (C).

(c1): an organopolysiloxane represented by the following formula:

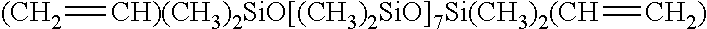

and having a viscosity of 7 mPa·s and a vinyl group content of about 7.49 mass %.

(c2): an organopolysiloxane represented by the following formula:

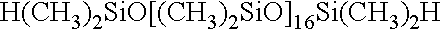

and having a viscosity of 15 mPa·s and a silicon atom-bonded hydrogen atom content of about 0.15 mass %.

(c3): 1,4-bis(dimethylsilyl)benzene

The following a hydrosilylation reaction catalyst was used as component (D).

(d1): a platinum complex with 1,3-divinyl-1,1,3,3-tetramethyldisiloxane in a 1,3-divinyl-1,1,3,3-tetramethyldisiloxane solution (platinum content=4 mass %)

The following hydrosilylation reaction inhibitor was used as component (E).

(e1): 1-ethynyl-cyclohexan-1-ol

The following non-functional organopolysiloxane resin was used as component (F).

(f1): an organopolysiloxane resin represented by the following average unit formula:

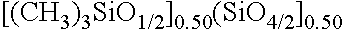

TABLE 1

| | | | Examples | | | |
|---|---|---|---|---|---|---|
| | | | IE1 | IE2 | IE3 | IE4 |
| Formulation | (A) | (a1) | 69.1 | 65.0 | 70.0 | 65.0 |
| of curable | | (a2) | 0 | 0 | 0 | 0 |
| silicone | (B) | (b1) | 14.7 | 13.9 | 14.9 | 13.9 |
| composition | | (b2) | 8.3 | 12.0 | 11.5 | 13.8 |
| (parts by | | (b3) | 0 | 0 | 0 | 0 |
| mass) | | (b4) | 0 | 0 | 0 | 0 |
| | (C) | (c1) | 7.9 | 9.1 | 3.6 | 7.3 |
| | | (c2) | 0 | 0 | 0 | 0 |
| | | (c3) | 0 | 0 | 0 | 0 |
| | (D) | (d1) | 0.013 | 0.013 | 0.013 | 0.013 |
| | (E) | (e1) | 0.005 | 0.005 | 0.005 | 0.005 |
| | (F) | (f1) | 0 | 0 | 0 | 0 |

| Content of component (B) (mass %) | | 23.0 | 25.9 | 26.4 | 27.7 |
|---|---|---|---|---|---|
| Content of component (C) (mass %) | | 7.9 | 9.1 | 3.6 | 7.3 |
| SiH/Vi ratio | | 0.34 | 0.50 | 0.50 | 0.60 |
| Viscosity at 25° C. (mPa · s) | | 94,930 | 8,573 | 81,600 | 8,196 |
| Properties | Storage Modulus (Pa) | 1.20E+06 | 3.67E+05 | 6.60E+06 | 9.58E+05 |
| at 20° C. | Loss Modulus (Pa) | 1.47E+06 | 5.61E+05 | 2.29E+06 | 7.85E+05 |
| | tan δ | 1.2 | 1.5 | 0.3 | 0.8 |
| Properties | Storage Modulus (Pa) | 2.07E+01 | 1.40E+01 | 1.56E+03 | 1.42E+02 |
| at 100° C. | Loss Modulus (Pa) | 1.33E+03 | 8.66E+02 | 1.74E+04 | 2.00E+03 |
| | tan δ | 64.5 | 61.7 | 11.2 | 14.1 |

| | | | | |
|---|---|---|---|---|
| Melt Viscosity at 100° C. (Pa · s) | 209 | 133 | 2836 | 361 |

| | | | Examples | | | |
|---|---|---|---|---|---|---|
| | | | IE5 | IE6 | IE7 | IE8 |
| Formulation | (A) | (a1) | 63.6 | 65.0 | 65.3 | 0 |
| of curable | | (a2) | 0 | 0 | 0 | 74.0 |
| silicone | (B) | (b1) | 18.8 | 3.5 | 16.1 | 11.6 |
| composition | | (b2) | 9.5 | 3.4 | 8.1 | 14.4 |
| (parts by | | (b3) | 0 | 0 | 0 | 0 |
| mass) | | (b4) | 0 | 0 | 0 | 0 |
| | (C) | (c1) | 8.1 | 7.7 | 7.0 | 0 |
| | | (c2) | 0 | 20.4 | 0 | 0 |
| | | (c3) | 0 | 0 | 3.5 | 0 |
| | (D) | (d1) | 0.013 | 0.013 | 0.013 | 0.013 |
| | (E) | (e1) | 0.005 | 0.005 | 0.005 | 0.005 |
| | (F) | (f1) | 21.2 | 0 | 0 | 0 |

| Content of component (B) (mass %) | | 28.3 | 6.9 | 24.2 | 16.0 |
|---|---|---|---|---|---|
| Content of component (C) (mass %) | | 8.1 | 28.1 | 10.5 | 0.0 |
| SiH/Vi ratio | | 0.35 | 0.60 | 0.57 | 0.61 |
| Viscosity at 25° C. (mPa · s) | | 28,420 | 39,130 | 5,517 | 2,262 |
| Properties | Storage Modulus (Pa) | 9.18E+04 | 1.28E+05 | 2.83E+06 | 5.88E+05 |
| at 20° C. | Loss Modulus (Pa) | 2.98E+05 | 2.78E+05 | 2.33E+06 | 1.34E+06 |
| | tan δ | 3.2 | 2.2 | 0.8 | 2.3 |
| Properties | Storage Modulus (Pa) | 2.19E+00 | 1.49E+03 | 3.48E+02 | 1.51E+01 |
| at 100° C. | Loss Modulus (Pa) | 2.84E+02 | 3.28E+03 | 4.88E+03 | 1.58E+03 |
| | tan δ | 129.7 | 2.2 | 14.0 | 104.1 |

| | | | | |
|---|---|---|---|---|
| Melt Viscosity at 100° C. (Pa · s) | 47 | 657 | 822 | 223 |

| | | | Comparative Examples | | | |
|---|---|---|---|---|---|---|
| | | | CE1 | CE2 | CE3 | CE4 |
| Formulation | (A) | (a1) | 75.0 | 70.0 | 65.0 | 65.0 |
| of curable | | (a2) | 0 | 0 | 0 | 0 |
| silicone | (B) | (b1) | 0 | 0 | 0 | 0 |
| composition | | (b2) | 0 | 0 | 0 | 0 |
| (parts by | | (b3) | 0 | 0 | 0 | 0 |
| mass) | | (b4) | 0 | 0 | 0 | 0 |
| | (C) | (c1) | 0 | 6.7 | 13.3 | 7.8 |
| | | (c2) | 25.0 | 23.3 | 21.7 | 27.2 |
| | | (c3) | 0 | 0 | 0 | 0 |
| | (D) | (d1) | 0 | 0 | 0.013 | 0.013 |
| | (E) | (e1) | 0.005 | 0.005 | 0.005 | 0.005 |
| | (F) | (f1) | 0 | 0 | 0 | 0 |

| Content of component (B) (mass %) | | 0 | 0 | 0 | 0 |
|---|---|---|---|---|---|
| Content of component (C) (mass %) | | 25.0 | 30.0 | 35.0 | 35.0 |
| SiH/Vi ratio | | 0.71 | 0.52 | 0.39 | 0.61 |
| Viscosity at 25° C. (mPa · s) | | Not measurable | Not measurable | 89,540 | 155,000 |
| Properties | Storage Modulus (Pa) | 2.79E+04 | 3.76E+02 | 1.44E+04 | 1.61E+05 |
| at 20° C. | Loss Modulus (Pa) | 1.35E+05 | 8.33E+03 | 6.57E+04 | 1.88E+04 |
| | tan δ | 4.8 | 22.1 | 4.6 | 11.4 |
| Properties | Storage Modulus (Pa) | 1.72E+00 | 1.16E−01 | 1.36E+04 | 6.27E−01 |
| at 100° C. | Loss Modulus (Pa) | 2.52E+02 | 2.85E+01 | 8.13E+03 | 6.63E+01 |
| | tan δ | 146.7 | 245.1 | 87.3 | 0.6 |

| | | | | |
|---|---|---|---|---|
| Melt Viscosity at 100° C. (Pa · s) | 37.6 | 4.4 | 40.2 | Not meltable |

| | | | Comparative Examples | | |
|---|---|---|---|---|---|
| | | | CE5 | CE6 | CE7 |
| Formulation | (A) | (a1) | 65.0 | 65.0 | 50.3 |
| of curable | | (a2) | 0 | 0 | 0 |
| silicone | (B) | (b1) | 13.9 | 13.9 | 25.2 |
| composition | | (b2) | 7.8 | 18.8 | 17.5 |
| (parts by | | (b3) | 0 | 0 | 0 |
| mass) | | (b4) | 0 | 0 | 0 |
| | (C) | (c1) | 13.3 | 2.3 | 7.0 |
| | | (c2) | 0 | 0 | 0 |
| | | (c3) | 0 | 0 | 0 |
| | (D) | (d1) | 0.013 | 0.013 | 0.013 |
| | (E) | (e1) | 0.005 | 0.005 | 0.005 |
| | (F) | (f1) | 0 | 0 | 0 |

| Content of component (B) (mass %) | | | 21.7 | 32.7 | 42.8 |
|---|---|---|---|---|---|
| Content of component (C) (mass %) | | | 13.3 | 2.3 | 7.0 |
| SiH/Vi ratio | | | 0.30 | 0.91 | 0.56 |
| Viscosity at 25° C. (mPa · s) | | | 9,366 | 5,411 | 233 |
| | Properties | Storage Modulus (Pa) | 1.64E+03 | 3.40E+06 | 4.85E+04 |
| | at 20° C. | Loss Modulus (Pa) | 1.88E+04 | 1.45E+06 | 6.13E+04 |
| | | tan δ | 11.4 | 0.4 | 1.3 |
| | Properties | Storage Modulus (Pa) | 6.27E−01 | 8.33E+05 | 2.70E+00 |
| | at 100° C. | Loss Modulus (Pa) | 6.63E+01 | 4.83E+05 | 6.19E+01 |
| | | tan δ | 105.8 | 0.6 | 23.0 |

| | | | |
|---|---|---|---|
| Melt Viscosity at 100° C. (Pa · s) | 10.8 | Not meltable | 11 |

Comparative Examples

| | | | CE8 | CE9 |
|---|---|---|---|---|
| Formulation | (A) | (a1) | 64.5 | 67.0 |
| of curable | | (a2) | 0 | 0 |
| silicone | (B) | (b1) | 0 | 0 |
| composition | | (b2) | 0 | 8.0 |
| (parts by | | (b3) | 10.0 | 0 |
| mass) | | (b4) | 0 | 15.0 |
| | (C) | (c1) | 4.0 | 10.0 |
| | | (c2) | 21.5 | 0 |
| | | (c3) | 0 | 0 |
| | (D) | (d1) | 0.013 | 0.013 |
| | (E) | (e1) | 0.005 | 0.005 |
| | (F) | (f1) | 0 | 0 |

| Content of component (B) (mass %) | | | 10.0 | 23.0 |
|---|---|---|---|---|
| Content of component (C) (mass %) | | | 25.5 | 10.0 |
| SiH/Vi ratio | | | 0.57 | 0.58 |
| Viscosity at 25° C. (mPa · s) | | | 218,000 | Not measurable |
| | Properties | Storage Modulus (Pa) | 3.97E+05 | Not measurable |
| | at 20° C. | Loss Modulus (Pa) | 5.84E+05 | Not measurable |
| | | tan δ | 1.5 | Not measurable |
| | Properties | Storage Modulus (Pa) | 2.68E+00 | Not measurable |
| | at 100° C. | Loss Modulus (Pa) | 1.85E+04 | Not measurable |
| | | tan δ | 0.7 | Not measurable |

| | | |
|---|---|---|
| Melt Viscosity at 100° C. (Pa · s) | Not meltable | Not measurable |

Comparative Examples CE1 and CE2 are representative examples of conventional silicone hotmelt composition which demonstrates the use of 70 to 75 mass % of (A) organopolysiloxane resins gives hotmelt property without component (B) and (D).

Comparative Examples CE1 and CE2 affords non-flowable solid at 25° C. and sticky surface having low storage modulus such as 2.79×10⁴ Pa and 376 Pa even at 20° C., respectively.

Comparative Examples CE3 and CE4 demonstrates curable silicone compositions including component (D) without component (B). Although compositions according to Comparative Examples CE3 and CE4 are flowable viscous liquid (89,540 mPa·s and 155,000 mPa·s, respectively at 25° C.), Comparative Example CE3 shows sticky surface having low modulus (1.44×10⁴ Pa at 20° C.) after hydrosilylation cure (SiH/Vi ratio=0.39). And, Comparative Example CE4 does not show hotmelt property at 100° C. (SiH/Vi ratio=0.60). Therefore, by using component (A), (C), and (D), it is difficult to obtain solventless curable composition exhibiting both flowability at room temperature before hydrosilylation cure and non(or less)-sticky surface at room temperature with hotmelt property after hydrosilylation cure.

In contrast, Examples IE1 to IE8 show that curable silicone compositions including component (B) as described herein are flowable at 25° C., and have high storage modulus (at least higher than 9×10⁴ Pa) after hydrosilylation cure, which affords none-sticky surface with having hotmelt property. When Comparative Examples CE3, CE4 and Examples IE2, IE4, IE6, IE7 are compared, the use of component (B) is thought to impart low viscosity of curable silicone composition before hydrosilylation cure, as well as high modulus (none-stickiness) at room temperature with having hotmelt property after hydrosilylation cure.

Comparative Examples CE5, CE6 and Examples IE1 to IE8 demonstrate curable silicone compositions including component (B) as described herein. When Comparative Examples CE5, CE6 and Examples IE1 to IE8 are compared, SiH/Vi Ratio is also thought to impart surface stickiness (modulus), and hotmelt property. Although Comparative Example CE5 shows hotmelt property, it has very sticky surface and low storage modulus (1,640 Pa) at 20° C. after hydrosilylation cure when SiH/Vi Ratio is 0.30. Moreover, When SiH/Vi ratio is 0.91, it does not have hotmelt property as shown in Comparative Example CE6. Without wishing to be bound by theory, it is thought that curable silicone composition affords non-sticky surface and hotmelt property after hydrosilylation cure when SiH/Vi Ratio is more than 0.30 and not more than 0.90.

Comparative Example CE8 shows non-reactive organosiloxane oligomer (b3) having silicone-bonded aryl groups in a molecule is not effective to obtain curable silicone composition described herein. In addition, Comparative Example CE9 shows high molecular weight organosiloxane polymer (b4) having silicon atom-bonded aryl groups and silicon atom-bonded alkenyl group is not compatible with component (A), and thus inhomogeneous liquid is obtained.

### INDUSTRIAL APPLICABILITY

The curable silicone composition of the present invention has an excellent handleability at a room temperature without using a solvent, and cures to form a non-sticky cured product at a room temperature with an excellent melt viscosity by heating. Therefore, the curable silicone composition is useful for sealants, adhesives, or coatings of an optical semiconductor element in electric/electronic apparatus.

1. A curable silicone composition comprising:
(A) an organopolysiloxane resin represented by the following average unit formula: 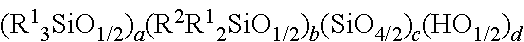
wherein each R¹ is independently an alkyl group; R² is an alkenyl group; and “a”, “b”, “c” and “d” are numbers satisfying the following conditions: a≥0, b>0, 0.3≤c≤0.7, 0≤d≤0.05, and a+b+c=1;
(B) an organosiloxane oligomer having a viscosity at 25° C. of not more than 1,000 mPa·s, and selected from (B₁) an organosiloxane oligomer having at least one silicon atom-bonded alkenyl group and at least one silicon atom-bonded aryl group in a molecule, (B₂) an organosiloxane oligomer having at least one silicon atom-bonded hydrogen atom and at least one silicon atom-bonded aryl group in a molecule, and a mixture of components (B₁) and (B₂);
(C) an organosilicon compound selected from (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, (C₃) a disilylbenzene represented by the following general formula: 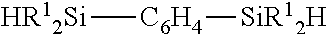
wherein each R¹ is as described above,
and a mixture thereof; and
(D) a catalytic amount of a hydrosilylation reaction catalyst,
wherein an amount of component (A) is in a range of from 60 to 75 mass %, an amount of component (B) is in a range of from 5 to 35 mass %, and an amount of component (C) is in a range of from 0 to 30 mass %, each based on a total mass of components (A) to (C), with the proviso that a molar ratio of all silicon atom-bonded hydrogen atoms relative to all silicon atom-bonded alkenyl groups in components (A) to (C) is more than 0.30 and not more than 0.90.

2. The curable silicone composition according to claim 1, wherein component
(B₁) is an organosiloxane oligomer represented by the following general formula: 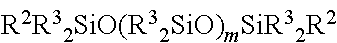
wherein each R² is independently an alkenyl group; each R³ is independently an alkyl group or an aryl group, with the proviso that at least one R³ is an aryl group; and “m” is an integer of 0 to 10.

3. The curable silicone composition according to claim 2, wherein component (B₁) is at least one selected from organosiloxane oligomers represented by the following formulae:

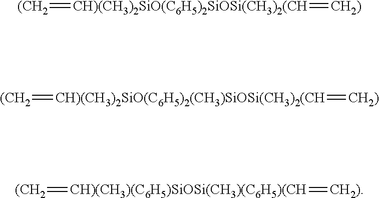

4. The curable silicone composition according to claim 1, wherein component (B₂) is an organosiloxane oligomer represented by the following general formula: 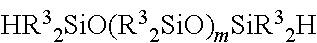
wherein each R³ is independently an alkyl group or an aryl group, with the proviso that at least one R³ is an aryl group; and “m” is an integer of 0 to 10.

5. The curable silicone composition according to claim 4, wherein component (B₂) is at least one selected from organosiloxane oligomers represented by the following formulae:

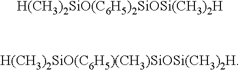

6. The curable silicone composition according to claim 1, further comprising:
(E) a hydrosilylation reaction inhibitor, in an amount of 0.1 to 10,000 ppm in this component in terms of mass units with respect to the composition.

7. The curable silicone composition according to claim 6, further comprising:
(F) an adhesion promotor, in an amount of at most 10 parts by mass relative to 100 parts by mass of a total mass of components (A) to (C).

8. A cured product obtained by curing the curable silicone composition according to claim 1.

9. The curable silicone composition according to claim 2, wherein component (B₂) is an organosiloxane oligomer represented by the following general formula: 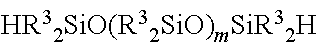
wherein each R³ is independently an alkyl group or an aryl group, with the proviso that at least one R³ is an aryl group; and “m” is an integer of 0 to 10.

10. The curable silicone composition according to claim 9, wherein component (B₂) is at least one selected from organosiloxane oligomers represented by the following formulae:

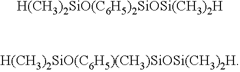

11. The curable silicone composition according to claim 3, wherein component (B₂) is at least one selected from organosiloxane oligomers represented by the following formulae:

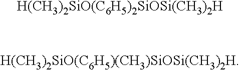

12. The curable silicone composition according to claim 1, further comprising:
(F) an adhesion promotor, in an amount of at most 10 parts by mass relative to 100 parts by mass of a total mass of components (A) to (C).
